(19) United States
(12) Patent Application Publication
(10) Pub. No.: US 2009/0009454 A1
(43) Pub. Date: Jan. 8, 2009

(54) Liquid crystal display device

(75) Inventor: Takayoshi Urisu, Osaka (JP)

Correspondence Address: Yokoi & Co., U. S. A., Inc., 13700 Marina Pointe Drive # 723, Marina Del Rey, CA, 90292, US

(73) Assignee: Funai Electric Co., Ltd., Osaka (JP)

(21) Appl. No.: 12/217,154

(22) Filed: Jul. 2, 2008

(30) Foreign Application Priority Data
Jul. 4, 2007 (JP) JP2007-176637

(51) Int. Cl. G09G 3/36

(52) U.S. Cl. 345/87

(57) ABSTRACT

A drive data output unit having a predetermined number of drive data output terminals arranged each for outputting the drive data; a display panel, in which the number of pixels arranged in a lateral direction is an integral multiplication of the number of drive data output terminals; a plurality of data lines connected respectively to the drive data output terminals of the drive data output unit on an input side of the data lines, and each branched to be the integral multiplication and connected respectively to the pixels consecutive in the lateral direction; gate signal output unit for specifying the pixels by line, to which the drive data are output; and pixel count conversion unit for converting the number of pixels of obtained image data into a number corresponding to the number of drive data output terminals, and supplying the drive data output unit with the converted image data.

### CROSS-REFERENCES TO RELATED APPLICATIONS

The present application is related to the Japanese Patent Application. No. 2007-176637, filed Jul. 4, 2007, the entire disclosure of which is expressly incorporated by reference herein.

### BACKGROUND OF THE INVENTION

1. Field of the Invention

The present invention relates to a liquid crystal display device, and in particular to a liquid crystal display device, which executes pixel count conversion on image data in accordance with the resolution of the display panel.

2. Description of the Related Art

Liquid crystal display devices have a plurality of pixels arranged in a matrix to form a screen. In the liquid crystal devices, a unit pixel is composed of three colors of pixels RGB, and the resolution thereof is determined by the number of unit pixels forming the screen. As an example of the resolution of the screen, certain standards such as QVGA (320×240), WXGA (1366×768), and full HD (1920×1080) are set by the numbers of unit pixels arranged in horizontal and vertical directions. When displaying image data on the liquid crystal display devices, it is required to perform pixel count conversion so as that the resolution of the obtained image data matches the resolution of the liquid crystal display devices.

The region for performing the pixel count conversion in the liquid crystal display devices is implemented in a single chipset together with, for example, an image processing section for executing an image process on the image data. Therefore, in order for coping with an attempt to make the liquid crystal display devices high-resolution, it is required to improve the processing capacity of the entire chipset. Further, the price of the chipset used therefor also rises in accordance with improvement in the processing capacity.

JP-A-2006-301166 discloses a technology of dividing the drive data output from a source driver by a demultiplexer circuit and then outputting the drive data thus divided in order for displaying image data with low resolution on a high-resolution liquid crystal display device.

Such a technology makes it possible to display the image with low resolution on the high-resolution liquid crystal display device.

Further, JP-A-Hei10 (1998)-260657 discloses a technology of inputting a multiscan control signal for driving each of the pixels of the liquid crystal panel to a latch address control circuit and a data control circuit to latch a single pixel of the display data two or more times, thereby displaying the display data with low resolution on the high-resolution liquid crystal panel.

Further, as a similar technology for displaying the image data with low resolution on the high-resolution liquid crystal panel, JP-A-Hei10 (1998)-240196 discloses a technology of executing sampling of the image data with a clock signal corresponding to the number of dots arranged in the horizontal direction to replace the missing pixel data with the adjacent pixel data.

The invention described in JP-A-2006-301166 has the following problems. That is, since the process for expanding or shrinking the image data is performed using the demultiplexer circuit, the cost thereof rises. Further, in the case in which the demultiplexer circuit is implemented inside the liquid crystal panel, an additional space equivalent to the size of the circuit is required, thus the liquid crystal panel is unnecessarily enlarged.

Further, the inventions described in JP-A-Hei10 (1998)-260657 and JP-A-Hei10 (1998)-240196 have the following problem. That is, since the pixel count is converted by latching (or sampling) the display data, improvement in the processing capacity of the control circuit becomes necessary, thus increasing the cost of the control circuit.

### BRIEF SUMMARY OF THE INVENTION

By driving a high-resolution liquid crystal display device using low-priced and low-resolution pixel count conversion unit, a low-cost liquid crystal display device is provided.

The present invention discloses, a liquid crystal display device, which has a plurality of pixels filled with a liquid crystal material and arranged in a matrix to form a screen, and inputs drive data sequentially to the pixels, thereby driving the screen, including drive data output unit having a predetermined number of drive data output terminals arranged each for outputting the drive data, a display panel, in which the number of pixels arranged in a lateral direction is an integral multiplication of the number of drive data output terminals, a plurality of data lines connected respectively to the drive data output terminals of the drive data output unit on an input side of the data lines, and each branched to be the integral multiplication and connected respectively to the pixels consecutive in the lateral direction, gate signal output unit for specifying the pixels by line, to which the drive data are output, and pixel count conversion unit for converting the number of pixels of obtained image data into a number corresponding to the number of drive data output terminals, and supplying the drive data output unit with the converted image data.

In the invention configured as described above, the number of pixels arranged in the lateral direction in the display panel is arranged to be an integer multiplication of the number of drive data output terminals. In such a display panel, the pixel count conversion unit firstly converts the number of pixels of the obtained image data so as to correspond to the number of drive data output terminals, and supplies it to the drive data output unit. Subsequently, the drive data output unit generates the drive data from the image data thus converted, and supplies it to the pixels. On this occasion, the data lines connecting the drive data output unit and the pixels are connected respectively to the drive data output terminals on the input side thereof, and branched to be the integral multiplication thereof described above on the output side thereof to be connected to the pixels consecutive in the lateral direction, thereby supplying the drive data output from each of the drive data output terminals to a plurality of pixels in a branched manner. Further, the gate signal output unit specifies the pixels, to which the drive data are output, by line to drive the pixels.

Thus, it becomes possible to drive a predetermined multiple number of pixels consecutive in the lateral direction with each drive data correspondingly to the number of branches of each of the data lines on the output side thereof, thereby reducing the number of pixels of the image data. Therefore, it is required for the pixel count conversion unit only to convert the image data so as to have the resolution lower than the number of pixels of the screen, thus it becomes possible to drive the screen with a high resolution using the pixel count conversion unit, which can only convert low resolution data. Therefore, since the maximum processing capacity required to the pixel count conversion unit is reduced, the low-priced pixel conversion unit can be used, thus the cost can be reduced.

Further, by forming a unit dot of the image with a plurality of pixels, even if a defective pixel dot occurs, the information of the image can be complemented with the remaining pixels.

Here, the input side of the data line denotes the side thereof connected to the drive data output unit. Further, the output side thereof denotes the side thereof connected to the respective pixels.

Further, the pixels are not limited to the parts in the liquid crystal layer filled with the liquid crystal material, but include the electrodes for supplying the liquid crystal layer with electrical charge and switching unit for supplying the electrodes with the electrical charge.

### BRIEF DESCRIPTION OF THE DRAWINGS

It is to be understood that the drawings are to be used for the purposes of exemplary illustration only and the drawings are to be used not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

FIG. 1 is a diagram corresponding to the appended claims according to the present invention.

FIG. 2 is a block configuration diagram showing a liquid crystal display device 100 according to the present invention.

FIG. 3 is a diagram showing drive waveforms of pixels P(i′, j′) of a display panel 40 in the i'th column and the i'+1th column.

FIG. 4 is a diagram showing a screen of the liquid crystal device 100 according to the present invention.

### DETAILED DESCRIPTION OF THE INVENTION

Hereinafter, some embodiments of the present invention will be explained along the following order.
1. Configuration of the Liquid Crystal Display Device
2. Operation and Advantages of the Liquid Crystal Display Device
3. Various Modified Examples
4. Conclusion

1. Configuration of the Liquid Crystal Display Device

In the present invention, a high-resolution liquid crystal screen is driven using pixel count conversion unit capable of converting only the low maximum resolution in the liquid crystal display device having a plurality of pixels filled with a liquid crystal material arranged in a matrix.

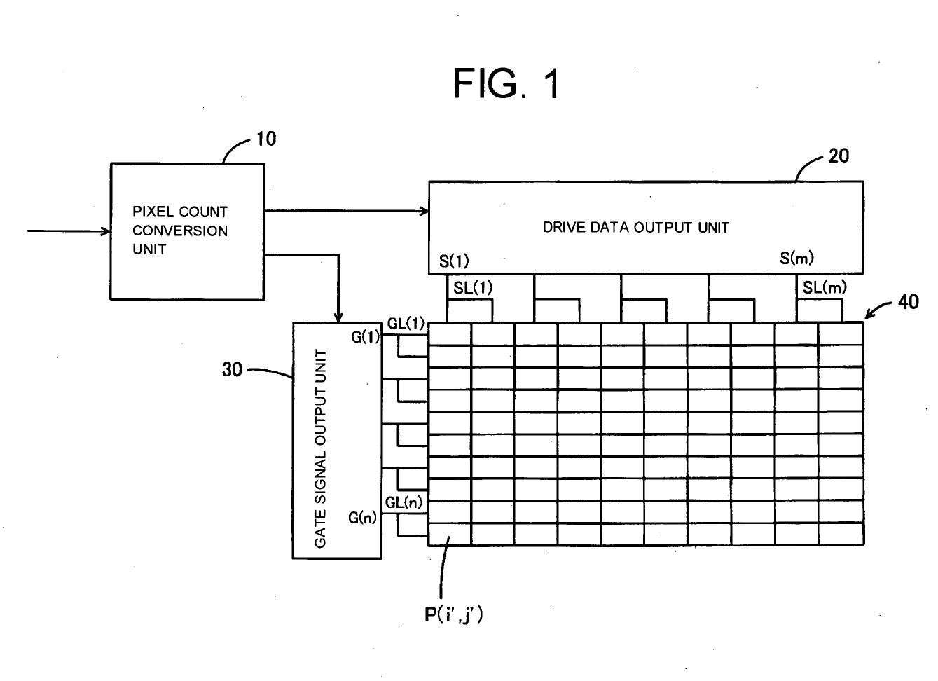

FIG. 1 is a diagram corresponding to the appended claims according to the present invention. According to the diagram, the liquid crystal display device 100 has the pixels P(i′, j′) filled with the liquid crystal material arranged in a matrix to form the screen, and inputs drive data sequentially to the pixels P(i′, j′), thereby driving the screen. The liquid crystal display device 100 includes drive data output unit 20 having a predetermined number of drive data output terminals for outputting the drive data arranged therein, a display panel 40 in which the number of pixel lines arranged in a lateral direction is an integral multiplication of the number of drive data output terminals, data lines SL(i) each connected to the drive data output unit 20 on the input side thereof and branched to be the integral multiplication on the output side so as to be connected respectively to the integral number of pixels P(i′, j′) consecutive in the lateral direction, gate signal output unit 30 for specifying the pixels P(i′, j′) by line to which the drive data are output, and pixel count conversion unit 10 for converting the number of pixels of obtained image data into a number corresponding to the number of drive data output terminals S(i) and supplying it to the drive data output unit 20 (wherein i=1 through m, j=1 through n, i′=1 through 2m, and j′=1 through 2n).

Here, the data lines SL(i) are each branched into a plural number on the output side connected to respective one of the pixels P(i′, j′), and connected respectively to the pixels consecutive in the lateral direction. Specifically, in the case in which the number of branches of each of the data lines SL(i) is N (N is an integer), the drive data output unit 20 can output the same drive signal to the consecutive N pixels P(i′, j′). Thus, the drive signals, which is N (N is an integer) times as many as the pixels of the image data input to the drive data output unit in the horizontal direction, are supplied to the pixels P(i′, j′) of the display panel 40 arranged in the horizontal direction. Thus, it is enough for the pixel count conversion unit 10 to be provided with the processing capacity of converting the pixels of the image data to be output to the drive data output unit 20 corresponding to one Nth the entire pixels arranged in the horizontal direction of the display panel 40. Further, by branching the gate lines GL(j) in accordance with the number of branches of the data lines SL(i), it is possible to adjust the horizontal to vertical ratio of the array of the pixels P(i′, j′) supplied with the same data.

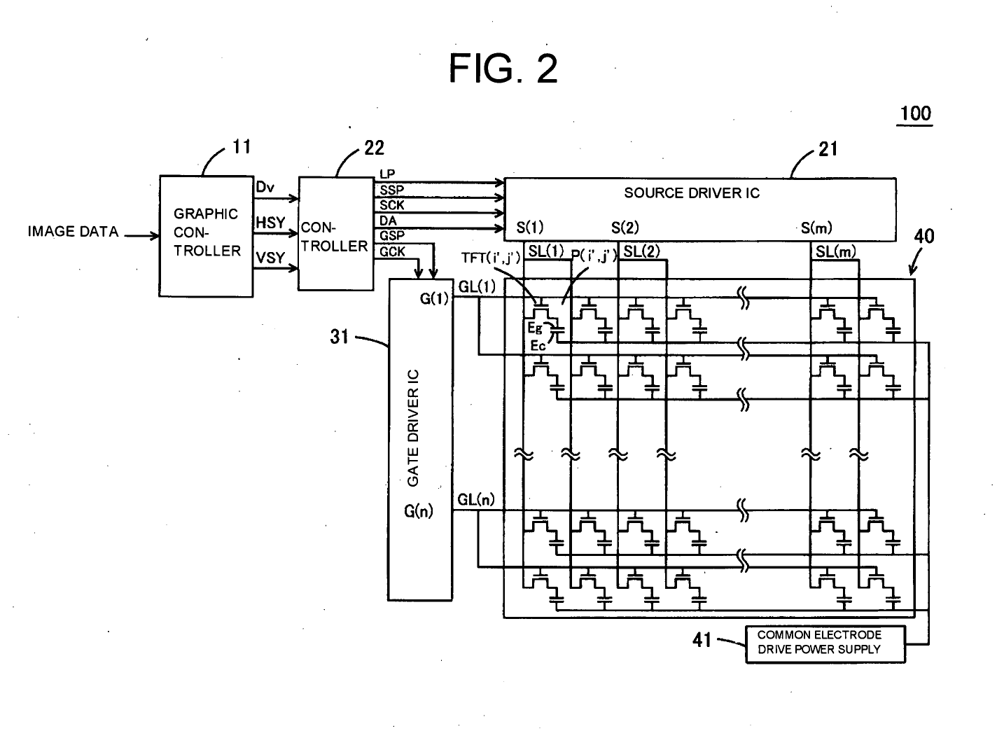

FIG. 2 is a block configuration diagram showing a liquid crystal display device 100 according to the present invention. The liquid crystal display device 100 is composed of a graphic controller 11 for executing a predetermined signal processing on the obtained image data, a source driver IC 21 for outputting the drive data for driving the pixels P(i′, j′) of the display panel, a gate driver IC 31 for selecting the pixels P(i′, j′) to which the drive data are output, and a controller 22 for controlling the source driver IC 21 and the gate driver IC 31 based on the image data on which the pixel count conversion is executed. In the present liquid crystal display device 100, the graphic controller 11 realizes the function of the pixel count conversion unit 10. Further, the drive data output unit 20 is realized by the source driver IC 21 and the controller 22, and the gate signal output unit 30 is realized by the gate driver IC 31.

The graphic controller 11 is, for example, a chipset having a plurality of signal processing chips built therein, and executes a predetermined signal processing on the image data obtained from a front module (not shown). Here, the image data denotes a signal obtained by the front module, not shown, and is composed of digital image data Dv representing an image to be displayed, a horizontal sync signal HSY, and a vertical sync signal VSY. The graphic controller 11 executes a specific image processing on the obtained image data, and then converts the pixel count of the digital image data Dv. It should be noted that it is assumed that a graphic controller, which can convert the resolution no higher than the maximum resolution lower than the resolution of the display panel 40, is used as the graphic controller 11 according to the present invention, and that the graphic controller 11 can convert the obtained image data into any resolutions, providing the resolution of the image data is no higher than the maximum resolution.

The display panel has the plurality of pixels P(i′, j′) arranged in a matrix. The pixels P(i′, j′) are each composed of a liquid crystal layer as a transmissive element, an applying electrode for applying electric charge to the liquid crystal layer, and a respective one of TFT(i′, j′) as a switch for applying the drive voltage to the applying electrode. The applying electrode is composed of a pixel electrode Eg connected to a drain electrode of the respective one of the TFT(i′, j′), and a common electrode Ec connected to a common electrode drive power supply 41. The liquid crystal layer is held between the pixel electrode Eg and the common electrode Ec. Further, each of the TFT(i′, j′) is connected to the gate line GL(j) for supplying the gate signal at the gate electrode, and the data line SL(i) for supplying the drive data at the source electrode. Thus, when the gate signal is applied to the gate electrode in the condition in which the drive data is applied to the source electrode, the drive data is applied to pixel electrode Eg connected to the drain electrode.

The data lines SL(i) according to the present invention are connected respectively to the drive data output terminals S(i) of the source driver IC 21, and each branched on the output side thereof so as to be connected to the laterally consecutive pixels P(i′, j′). In the drawing, the data lines SL(i) are each branched into two on the output side thereof, and connected respectively to the source electrodes of the TFT(i′, j′) disposed in the i'th column and the i′+1th column adjacent to each other. Further, the gate lines GL(j) according to the present invention are connected respectively to the gate signal output terminals G(j) of the gate driver IC 31, and each branched on the output side thereof so as to be connected to the vertically consecutive TFT(i′, j′). According to the drawing, each of the gate lines GL(j) is branched into two on the output side in accordance with the number of branches of each of the data lines SL(i), and connected respectively to the TFT(i′, j′) in the j'th row and the j′+1th row.

The controller 22 obtains the image data input from the graphic controller 11, and outputs respective signals for controlling the source driver IC 21 and the gate driver IC 31. The controller 22 supplies the source driver IC 21 with a latch pulse LP, a source driver starting signal SSP, a source driver clock signal SCK, and a digital image signal DA based on the digital image data Dv and the sync signals HSY, VSY thus received. Further, the controller 22 supplies the gate driver IC 31 with a gate driver starting signal GSP and a gate driver clock signal GCK.

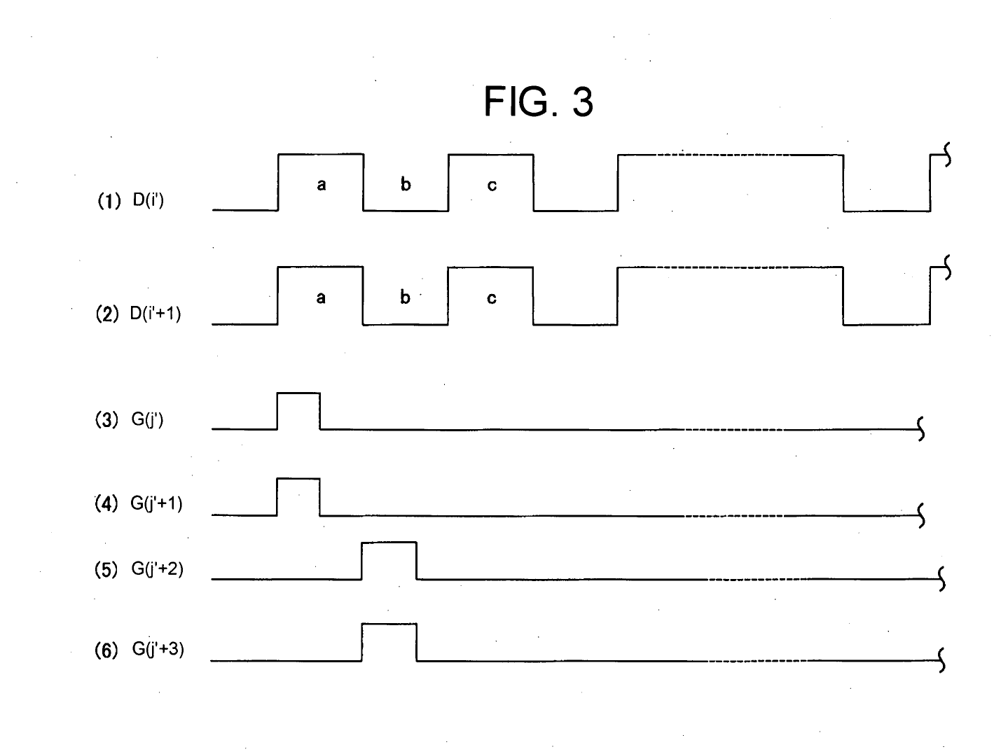

FIG. 3 is a diagram showing the drive waveforms of pixels P(i′, j′) of the display panel 40 in the i'th column and the i′+1th column. Here, D(i′) and D(i′+1) denote the drive data supplied to the pixel elements adjacent to each other from corresponding one of the data lines SL(i). It should be noted that the places in the drive data D(i′) and D(i′+1) denoted with the same symbols (a through c) represent the same data, respectively Further, GO(j′) denotes the gate signals supplied to the TFT(i′, j′) via the gate lines GL(j).

The source driver IC 21 obtains various data from the controller 22 to generate the drive data, and is provided with the drive data output terminals S(i) for outputting the drive data as many as one Nth (N is an integer) the pixels arranged laterally in the display panel 40. The source driver IC 21 firstly obtains the latch pulse LP, the source driver starting signal SSP, and the source driver clock signal SCK from the controller 22. Subsequently, the source driver 21 executes digital/analog conversion on the digital image signal DA to generate the drive signals, and outputs the drive signals from the respective drive data output terminals S(i) in sync with the timing of the respective signals thus obtained. Here, the number of drive data output terminals S(i) is a half the number of pixels arranged laterally in the display panel 40. Further, the drive data output terminals S(i) is connected respectively to the pixels P(i′, j′) in the i'th column and the i′+1th column laterally adjacent to each other via the data lines SL(i) to output the drive data to the pixels P(i′, j′) in the i'th column and the i′+1th column.

Based on the gate driver starting signal GSP and the gate driver clock signal GCK, the gate driver IC 31 sequentially selects the gate lines GL(j), and supplies the gate electrodes of the TFT(i′, j′) with the gate signals (waveforms (3) through (6) shown in FIG. 3) via the gate lines GL(j) thus selected. Here, the gate signal output terminals G(j) of the gate driver IC 31 are connected to the pixels P(i′, j′) in the j'th row and the j′+1th row vertically adjacent to each other via the gate lines GL(j) each branched into two on the output side thereof Therefore, the gate driver IC 31 outputs the gate signals GO(j′), GO(j′+1) from the gate signal output terminals G(j) to the pixels P(i′, j′) in the j'th row and the j′+1th row adjacent to each other. Thus, the TFT(i′, j′) apply the drive data D(i′), D(i′+1) to the liquid crystal layers of the pixels P(i′, j′), thereby realizing the every-two-line drive of the pixels P(i′, j′). On this occasion, the pixels P(i′, j′) in the i'th column and the i′+1th column are supplied with the same drive data.

2. Operation and Advantages of the Liquid Crystal Display Device

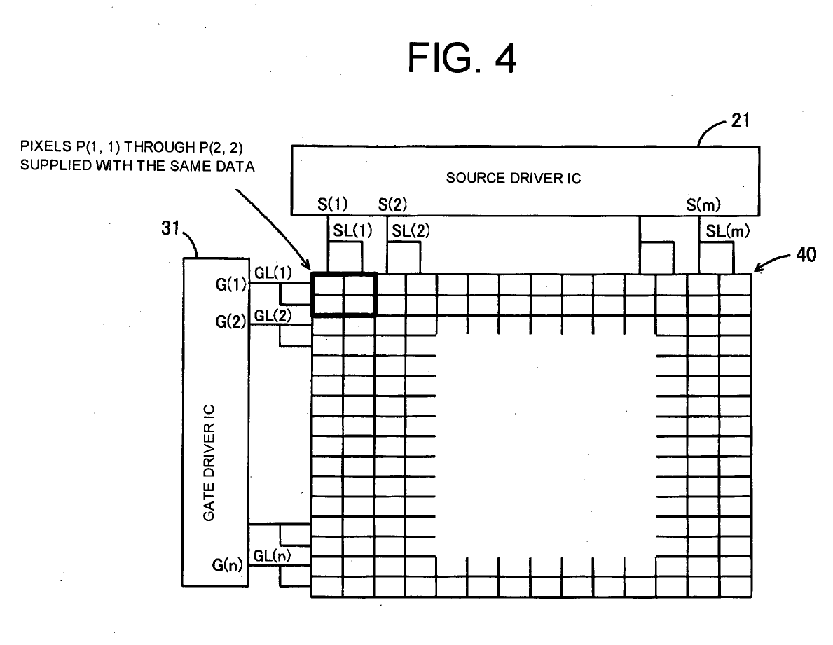

An operation and advantages of the liquid crystal display device according to the present invention will be explained with reference to FIG. 4.

The liquid crystal display device shown in FIG. 4 has a resolution compliant to the full HD standard of 1920×1080, and the maximum resolution the graphic controller can process corresponds to 1024×768 (XGA). Further, each of the data lines SL(i) has a single input and two branched outputs connected to the source electrodes of the TFT(i′, j′) of the pixels P(i′, j′) in the i'th column and the i′+1th column laterally adjacent to each other. Further, each of the gate lines GL(j) is branched into two on the output side, and connected to the gate electrodes of the TFT(i′, j′) of the pixels P(i′, j′) in the j'th row and the j′+1th row vertically adjacent to each other.

According to the configuration described above, the graphic controller 11 executes the pixel count conversion on the image data thus obtained so as to have the number of pixels of a half of 1920×1080 (i.e., 960×540), which is the resolution of the display panel 40, and outputs the image data thus converted to the controller 22. When the image data is input to the source driver IC 21 via the controller 22, the source driver IC 21 generates the drive data D(i′) (=D(i′+1)), and outputs the drive data to the respective data lines SL(1) through SL(m) from the drive data output terminals S(1) through S(m). Here, since the data lines SL(i) are each branched into two on the output side thereof, the same drive data D(i′), D(i′+1) are supplied respectively to the pixels P(i′, j′) in the i'th column and the i′+1th column adjacent to each other. Specifically, the drive data output via the data line SL(1) are supplied to the pixels P(1, j′) and P(2, j′) in the first column and the second column. Further, the gate driver IC 31 outputs the gate signals GO(j′), GO(j′+1) to the pixels P(i′, j′) in the j'th row and the j′+1th row vertically adjacent to each other, thereby realizing the two lines of horizontal scanning. Thus, the same drive data are set to the pixels P(1, 1) and P(2, 1) and the pixels P(1, 2) and P(2, 2) laterally adjacent to each other and supplied with the same drive data D(i′), D(i′+1), and one datum is thus displayed with four pixels as shown in the drawing.

Thus, even with the graphic controller 11, which can only convert up to the maximum number of pixels of 1024×768, it is possible to drive the display panel with the number of pixels of 1920×1080. Therefore, the graphic controller 11 with low processing capacity and accordingly low-price can be used, thereby reducing the cost. Further, the number of drive data output terminals S(i) and the number of gate signal output terminals G(j) can be set small with respect to the number of pixels of the display panel 40, thus the source driver IC 21 and the gate driver IC 31 can be made compact. Further, by forming a unit dot of the image with a plurality of pixels, even if a defective pixel dot occurs, the information of the image can be complemented with the remaining pixels.

3. Various Modified Examples

There are various modified examples of the liquid crystal display device according to the present invention.

It is also possible to realize the drive data output unit 20 and the gate signal output unit 30 using the wiring implemented to the glass substrate of the liquid crystal panel. As specific examples thereof, Chip On Glass (COG) and Chip On Film (COF) can be cited. Thus, it becomes possible to eliminate circuit boards for mounting elements of the source driver IC 21 and the gate driver IC 31, and the space of the circuit boards can be eliminated, thus making the liquid crystal display device 100 compact accordingly.

Further, although in the liquid crystal display device 100 described above, the ratio between the number of pixels arranged vertically and the number of pixels arranged laterally in the pixel area for representing the unit dot of the image data is set to one, there is no need for keeping the ratio. For example, the number of pixels arranged laterally in the pixel area can be an integral multiplication of the number of pixels arranged vertically therein. Specifically, in the case in which the data lines SL(i) are each branched into two, and the gate lines are not branched, it is possible to adopt the graphic controller 11 for converting the image data so as to have the resolution of 960×1080 in order for driving the display panel with the resolution of 1920×1080.

Further, the number of branches of each of the data lines SL(i) and each the gate lines GL(j) on the output side thereof is not limited to the numbers described above. For example, if the number of branches of each of the wiring lines is set to three, the conversion pixel count of the pixel count conversion unit 10 can be reduced accordingly.

4. Conclusion

The liquid crystal display device 100 has the pixels filled with the liquid crystal material arranged in a matrix to form the screen, and inputs the drive data sequentially to the pixels, thereby driving the screen. The liquid crystal display device 100 includes the drive data output unit 20 having a predetermined number of drive data output terminals for outputting the drive data arranged therein, a display panel 40 in which the number of pixel lines arranged in a lateral direction is an integral multiplication of the number of drive data output terminals, the data lines SL(i) each connected to the drive data output unit 20 on the input side thereof and branched to be the integral multiplication on the output side thereof so as to be connected respectively to the integral number of pixels consecutive in the lateral direction, the gate signal output unit 30 for specifying the pixels by line to which the drive data are output, and the pixel count conversion unit 10 for converting the number of pixels of obtained image data into the number corresponding to the number of drive data output terminals S(i) and supplying it to the drive data output unit 20.

The present invention discloses, a liquid crystal display device, which has a plurality of pixels filled with a liquid crystal material and arranged in a matrix to form a screen, and inputs drive data sequentially to the pixels, thereby driving the screen, including drive data output unit having a predetermined number of drive data output terminals arranged each for outputting the drive data, a display panel, in which the number of pixels arranged in a lateral direction is an integral multiplication of the number of drive data output terminals, a plurality of data lines connected respectively to the drive data output terminals of the drive data output unit on an input side of the data lines, and each branched to be the integral multiplication and connected respectively to the pixels consecutive in the lateral direction, gate signal output unit for specifying the pixels by line, to which the drive data are output, and pixel count conversion unit for converting the number of pixels of obtained image data into a number corresponding to the number of drive data output terminals, and supplying the drive data output unit with the converted image data.

In the invention configured as described above, the number of pixels arranged in the lateral direction in the display panel is arranged to be an integer multiplication of the number of drive data output terminals. In such a display panel, the pixel count conversion unit firstly converts the number of pixels of the obtained image data so as to correspond to the number of drive data output terminals, and supplies it to the drive data output unit. Subsequently, the drive data output unit generates the drive data from the image data thus converted, and supplies it to the pixels. On this occasion, the data lines connecting the drive data output unit and the pixels are connected respectively to the drive data output terminals on the input side thereof, and branched to be the integral multiplication thereof described above on the output side thereof to be connected to the pixels consecutive in the lateral direction, thereby supplying the drive data output from each of the drive data output terminals to a plurality of pixels in a branched manner. Further, the gate signal output unit specifies the pixels, to which the drive data are output, by line to drive the pixels.

Thus, it becomes possible to drive a predetermined multiple number of pixels consecutive in the lateral direction with each drive data correspondingly to the number of branches of each of the data lines on the output side thereof, thereby reducing the number of pixels of the image data. Therefore, it is required for the pixel count conversion unit only to convert the image data so as to have the resolution lower than the number of pixels of the screen, thus it becomes possible to drive the screen with a high resolution using the pixel count conversion unit, which can only convert low resolution data. Therefore, since the maximum processing capacity required to the pixel count conversion unit is reduced, the low-priced pixel conversion unit can be used, thus the cost can be reduced.

Further, by forming a unit dot of the image with a plurality of pixels, even if a defective pixel dot occurs, the information of the image can be complemented with the remaining pixels.

Here, the input side of the data line denotes the side thereof connected to the drive data output unit. Further, the output side thereof denotes the side thereof connected to the respective pixels.

Further, the pixels are not limited to the parts in the liquid crystal layer filled with the liquid crystal material, but include the electrodes for supplying the liquid crystal layer with electrical charge and switching unit for supplying the electrodes with the electrical charge.

Further, it is possible to modify the ratio between the number of the pixels arranged vertically and the number of pixels arranged laterally in the area composed of a plurality of pixels supplied with the same data in accordance with the configuration of the gate signal output unit. Therefore, in the present invention, the gate signal output unit has a configuration of being connected to the pixels using gate lines and outputting the gate signals via the gate lines to specify the pixels to which the drive data are output, each of the gate lines being branched on the output side of each of the gate lines to be connected respectively to vertically consecutive rows of the pixels.

According to the invention configured as described above, the ratio between the number of pixels arranged vertically and the number of pixels arranged laterally in the pixel area supplied with the same data can be modified by setting the number of branches of each of the gate lines on the output side thereof so as to correspond to the number of branches of each of the data lines.

Further, as a specific example of the ratio between the number of pixels arranged vertically and the number of pixels arranged laterally in the pixel area supplied with the same data as described above, the present invention has a configuration in which the number of branches of each of the gate lines on the output side of each of the gate lines is equal to the number of branches of each of the data lines on the output side of each of the data lines.

According to the invention configured as described above, since the numbers of branches in each of the gate lines and each of the data lines are arranged to be equal to each other, the ratio between the number of pixels arranged vertically and the number of pixels arranged laterally in the pixel area supplied with the same data becomes one, and the image can be made eye-friendly.

Further, the drive data output unit and the gate signal output unit are not limited to the circuit boards mounting the components, but various configurations therefor can be assumed. Therefore, in the present invention, the drive data output unit and the gate signal output unit can mainly be composed of wiring lines implemented in the display panel forming the screen.

As specific configurations thereof, Chip On Glass (COG) and Chip On Film (COF) can be cited.

According to the invention configured as described above, since the drive data output unit and the gate signal output unit are mainly composed of the wiring lines mounted on a glass substrate of the display panel, a circuit board for mounting the components can be eliminated, and thus the display panel can be made compact accordingly to the space for the circuit board thus eliminated.

Further, as a specific configuration of the present invention, in the present invention, the pixel count conversion unit is implemented in a chipset for executing a specific image processing on the obtained image data, and has the maximum number of pixels, up to which the pixel count conversion unit can convert, smaller than the number of pixels of the display panel, the drive data output unit and the gate signal output unit are mainly composed of wiring lines mounted on a glass substrate of the display panel, the display panel has the pixels arranged in the lateral direction double as many as the number of drive data output terminals, and the gate signal output unit has a configuration of being connected to the pixels using gate lines and outputting the gate signals via the gate lines to specify the pixels to which the drive data are output, each of the gate lines being branched into two on the output side of each of the gate lines to be connected respectively to vertically adjacent rows of the pixels.

Although the invention has been described in considerable detail in language specific to structural features or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A liquid crystal display device comprising:
a plurality of pixels filled with a liquid crystal material and arranged in a matrix to form a screen, including inputs that drive data sequentially to the pixels and thereby drive the screen;
drive data output unit having a predetermined number of drive data output terminals, with each output terminal arranged for outputting the drive data;
a display panel, in which the number of pixels arranged in a lateral direction is an integral multiple of the number of drive data output terminals;
a plurality of data lines connected respectively to the drive data output terminals of the drive data output unit on an input side of the data lines, and each branched is the integral multiple and connected respectively to the pixels consecutive in the lateral direction;
gate signal output unit for specifying the pixels by line, to which the drive data are output; and
pixel count conversion unit for converting the number of pixels of obtained image data into a number corresponding to the number of drive data output terminals, and supplying the drive data output unit with the converted image data.

2. The liquid crystal display device according to claim 1,
wherein the gate signal output unit has a configuration of outputting gate signals via gate lines, thereby specifying the pixels to which the drive data are output, and
the gate lines are each branched on an output side of each of the gate lines to be connected respectively to vertically consecutive rows of the pixels.

3. The liquid crystal display device according to claim 2,
wherein the number of branches of each of the gate lines on the output side of each of the gate lines is equal to the number of branches of each of the data lines on the output side of each of the data lines.

4. The liquid crystal display device according to claims 1
wherein the drive data output unit and the gate signal output unit are composed mainly of wiring lines.

5. The liquid crystal display device according to claims 1
wherein the drive data output unit and the gate signal output unit are implemented to a glass substrate of the display panel.

6. The liquid crystal display device according to claim 1,
wherein the pixel count conversion unit is implemented in a chipset for executing a specific image processing on the obtained image data, and has the maximum number of pixels, up to which the pixel count conversion unit can convert, smaller than the number of pixels of the display panel,
the drive data output unit and the gate signal output unit are mainly composed of wiring lines mounted on a glass substrate of the display panel,
the display panel has the pixels arranged in the lateral direction double as many as the number of drive data output terminals, and
the gate signal output unit has a configuration of being connected to the pixels using gate lines and outputting the gate signals via the gate lines to specify the pixels to which the drive data are output, each of the gate lines being branched into two on the output side of each of the gate lines to be connected respectively to vertically adjacent rows of the pixels.
